(19) United States
(12) Patent Application Publication
(10) Pub. No.: US 2022/0103870 A1
(43) Pub. Date: Mar. 31, 2022

(54) HOSPITALITY PROPERTY MANAGEMENT TOOL AND SYSTEM AND METHOD FOR USE OF SAME

(71) Applicant: Enseo, LLC, Plano, TX (US)

(72) Inventors: Thomas R. Miller, Plano, TX (US); Vanessa Ogle, Fairview, TX (US); William C. Fang, Plano, TX (US)

(21) Appl. No.: 17/548,517

(22) Filed: Dec. 11, 2021

Related U.S. Application Data
(63) Continuation-in-part of application No. 17/482,993, filed on Sep. 23, 2021.
Application No. 17/482,993 is a continuation of application No. 16/901,886, filed on Jun. 15, 2020, now Pat. No. 11,140,421.
Application No. 16/901,886 is a continuation of application No. 16/556,411, filed on Aug. 30, 2019, now Pat. No. 10,687,089.
Application No. 16/556,411 is a continuation of application No. 15/982,725, filed on May 17, 2018, now Pat. No. 10,405,008.
Application No. 15/982,725 is a continuation-in-part of application No. 15/824,766, filed on Nov. 28, 2017, now Pat. No. 10,123,056.
Application No. 15/824,766 is a continuation of application No. 15/417,554, filed on Jan. 27, 2017, now Pat. No. 9,832,489.
Application No. 15/417,554 is a continuation of application No. 15/074,067, filed on Mar. 18, 2016, now Pat. No. 9,560,388.
Application No. 15/074,067 is a continuation of application No. 14/803,428, filed on Jul. 20, 2015, now Pat. No. 9,326,009.
Application No. 14/803,428 is a continuation of application No. 14/294,123, filed on Jun. 2, 2014, now Pat. No. 9,088,828.
(60) Provisional application No. 63/132,829, filed on Dec. 31, 2020.
(60) Provisional application No. 62/508,166, filed on May 18, 2017.
(60) Provisional application No. 61/829,932, filed on May 31, 2013.

(51) Int. Cl. H04N 21/214; H04N 21/41; H04N 21/436; H04N 21/262; H04N 21/25; H04N 21/81; H04N 21/478

(52) U.S. Cl. CPC H04N 21/2143; H04N 21/4131; H04N 21/43615; H04N 21/262; H04N 21/436; H04N 21/8146; H04N 21/478; H04N 21/8126; H04N 21/25

(57) ABSTRACT

A hospitality property management tool and system and method for use of the same are disclosed. In one embodiment of the system, the system includes a thermostat located in a room at a hospitality establishment having multiple rooms. The thermostat stores various types of thermostat data and transmits the thermostat data to a server, which may be remote. The server receives and stores the thermostat data. The server may render a map view of the hospitality establishment based on obtained map data. The map view may include a graphical representation of the room and other rooms at the hospitality establishment. The server may annotate the graphical representation of the room with at least a portion of the thermostat data.

### PRIORITY STATEMENT & CROSS-REFERENCE TO RELATED APPLICATIONS

This application claims the benefit of U.S. Provisional Patent Application Ser. No. 63/132,829, entitled “Hospitality Property Management Tool and System and Method for Use of Same,” filed on Dec. 31, 2020, in the name of William C. Fang; which is hereby incorporated by reference, in entirety, for all purposes. This application is also a continuation in part of U.S. patent application Ser. No. 17/482,993, entitled “Hospitality Property Management Tool and System and Method for Use of Same,” filed on Sep. 23, 2021, in the names of William C. Fang et al.; which is a continuation of U.S. patent application Ser. No. 16/901,886, entitled “Hospitality Property Management Tool and System and Method for Use of Same” filed on Jun. 15, 2020, in the names of William C. Fang, et al., now U.S. Pat. No. 11,140,421 issued on Oct. 5, 2021; which is a continuation of U.S. patent application Ser. No. 16/556,411, entitled “Hospitality Property Management Tool and System and Method for Use of Same” filed on Aug. 30, 2019, in the names of William C. Fang, et al., now U.S. Pat. No. 10,687,089 issued on Jun. 16, 2020; which is a continuation of U.S. patent application Ser. No. 15/982,725, entitled “Hospitality Property Management Tool and System and Method for Use of Same” filed on May 17, 2018, in the names of William C. Fang, now U.S. Pat. No. 10,405,008 issued on Sep. 3, 2019; which claims priority from U.S. Patent Application Ser. No. 62/508,166, entitled “Hospitality Property Management Tool and System and Method for Use of Same” filed on May 18, 2017, in the name of Vanessa Ogle; all of which are hereby incorporated by reference, in entirety, for all purposes. U.S. patent application Ser. No. 15/982,725, entitled “Hospitality Property Management Tool and System and Method for Use of Same,” filed on May 17, 2018, now U.S. Pat. No. 10,405,008 issued on Sep. 20, 2018 is also a continuation-in-part of U.S. patent application Ser. No. 15/824,766 entitled “Set-Top Box with Interactive Portal and System and Method for Use of Same” filed on Nov. 28, 2017, in the names of Vanessa Ogle, et al., now U.S. Pat. No. 10,123,056 issued on Nov. 6, 2018; which is a continuation of U.S. patent application Ser. No. 15/417,554 entitled “Set-Top Box with Interactive Portal and System and Method for Use of Same” filed on Jan. 27, 2017 in the names of Vanessa Ogle, et al., now U.S. Pat. No. 9,832,489 issued on Nov. 28, 2017; which is a continuation of U.S. patent application Ser. No. 15/074,067 entitled “Set-Top Box with Interactive Portal and System and Method for Use of Same” filed on Mar. 18, 2016 in the names of Vanessa Ogle, et al., now U.S. Pat. No. 9,560,388 issued on Jan. 31, 2017; which is a continuation of U.S. patent application Ser. No. 14/803,428 entitled “Set-Top Box with Interactive Portal and System and Method for Use of Same” and filed on Jul. 20, 2015 in the names of Vanessa Ogle, et al., now U.S. Pat. No. 9,326,009 issued on Apr. 26, 2016; which is a continuation of U.S. patent application Ser. No. 14/294,123 entitled “Set-top Box with Interactive Portal and System and Method for Use of Same” and filed on Jun. 2, 2014 in the names of Vanessa Ogle, et al., now U.S. Pat. No. 9,088,828 issued on Jul. 21, 2015; which claims priority from U.S. Patent Application Ser. No. 61/829,932 entitled “On-Screen Display” and filed on May 31, 2013 in the name of Vanessa Ogle; all of which are hereby incorporated by reference, in entirety, for all purposes.

This application discloses subject matter related to the subject matter disclosed in the following commonly owned, co-pending U.S. patent application Ser. No. 17/548,513 entitled “Hospitality Property Management Tool and System and Method for Use of Same,” filed on Dec. 11, 2021, in the names of Thomas R. Miller et al.; which is hereby incorporated by reference, in entirety, for all purposes.

### TECHNICAL FIELD OF THE INVENTION

This invention relates, in general, to the management of hospitality real estate and, in particular, to property management tools and systems and methods for use of the same for the operation, control, and oversight of hospitality properties, such as lodging establishments, motels, or hotels, for example.

### BACKGROUND OF THE INVENTION

Without limiting the scope of the present invention, the background will be described in relation to property management in the hospitality industry, as an example. Property management in the hospitality industry requires a need for the asset to be cared for, monitored and accountability given for its useful life and condition. As property portfolios grow in the hospitality industry, the processes, systems and human resources required to manage the life cycle of all acquired property increases in complexity. As a result of limitations in existing technology, there is a need for improved systems and methods of providing understanding and visibility into the management of hospitality environments.

### SUMMARY OF THE INVENTION

It would be advantageous to achieve understanding and visibility into the management of hospitality environments. It would also be desirable to enable a computer-based solution that would enable property management tools to improve the operation, control, and oversight of hospitality properties, such as lodging establishments, motels, or hotels. To better address one or more of these concerns, property management tools and systems and methods for use of the same, are disclosed that are applicable to the hospitality industry. In one embodiment of the system, the system includes a thermostat located in a room at a hospitality establishment having multiple rooms. The thermostat stores various types of thermostat data and transmits the thermostat data to a remote server. The remote server receives and stores the thermostat data. The server may render a map view of the hospitality establishment based on obtained map data. The map view may include a graphical representation of the room and other rooms at the hospitality establishment. The server may annotate the graphical representation of the room with at least a portion of the thermostat data. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram depicting one embodiment of a system for providing hospitality property management according to the teachings presented herein;

FIG. 2A is a schematic diagram depicting one embodiment of the system of FIG. 1 within an on-property deployment;

FIG. 2B is a schematic diagram depicting one embodiment of the system of FIG. 1 within a cloud-computing deployment;

FIG. 3A is a front elevation view of one embodiment of the thermostat depicted in FIG. 1, according to the teachings presented herein;

FIG. 3B is a top plan view of the thermostat depicted in FIG. 3A;

FIG. 4A is a front elevation view of another embodiment of the thermostat depicted in FIG. 1, according to the teachings presented herein;

FIG. 4B is a top plan view of the thermostat depicted in FIG. 4A;

FIG. 5 is a functional block diagram depicting one embodiment of the thermostat presented in FIGS. 3A and 3B;

FIG. 6 is a functional block diagram depicting one operational embodiment of a portion of the thermostat in FIG. 5;

FIG. 7 is a functional block diagram depicting one embodiment of a server presented in FIGS. 2A and 2B;

FIG. 8 is a conceptual module diagram depicting a software architecture of an analytics application of some embodiments;

FIG. 9 is a conceptual module diagram depicting a software architecture of a map rendering application of some embodiments;

FIG. 10A is a schematic diagram depicting one embodiment of a map representation of a hospitality lodging establishment utilizing one embodiment of a hospitality property management tool presented herein;

FIG. 10B is a schematic diagram depicting one embodiment of a map representation of a floor of the hospitality lodging establishment presented in FIG. 10A; and

FIG. 11 is a flow chart depicting one embodiment of a method for providing hospitality property management according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

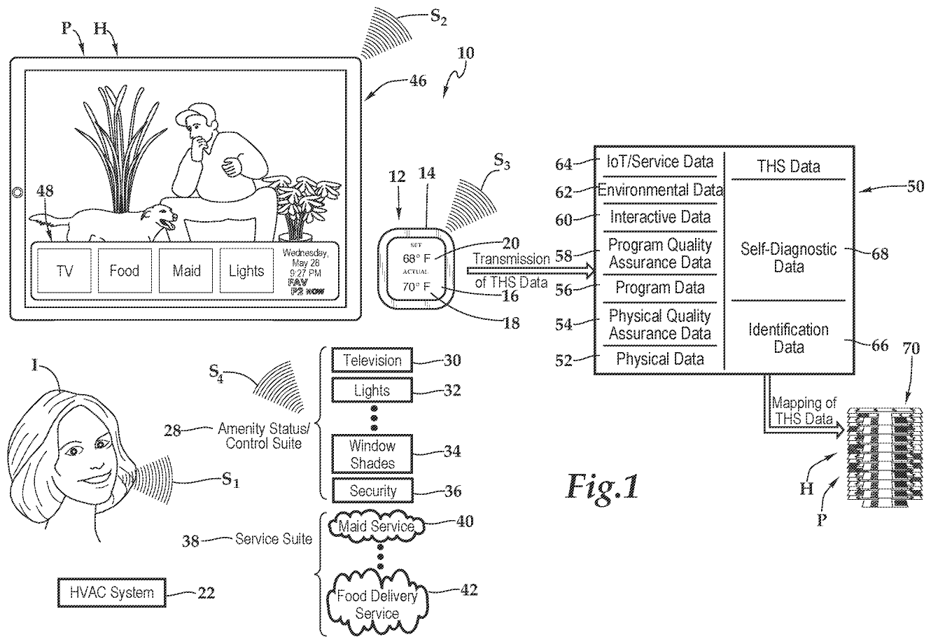

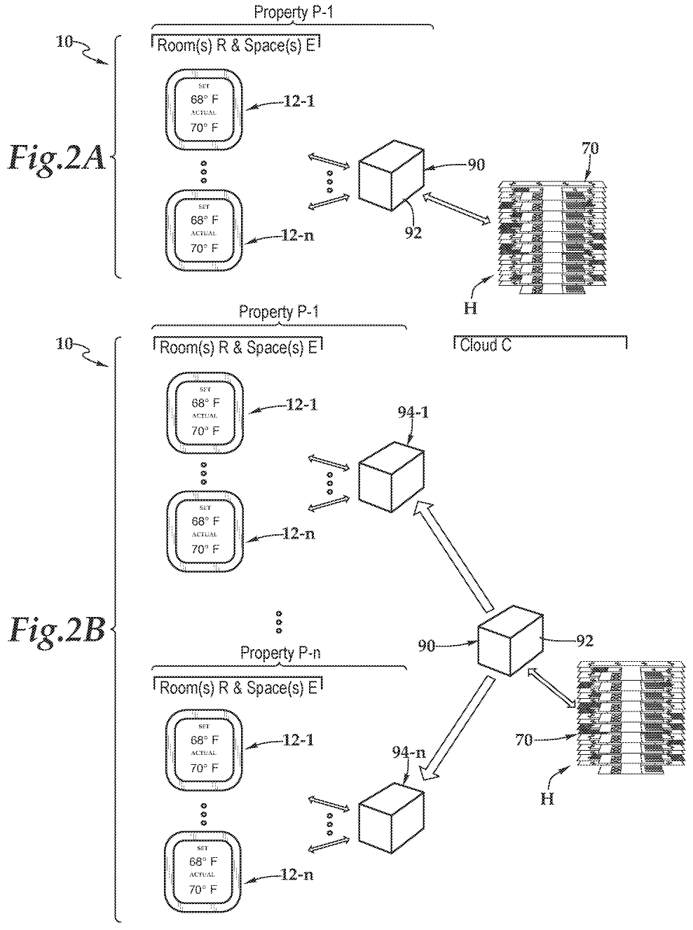

Referring initially to FIG. 1, therein is depicted one embodiment of a system 10 for the management of a hospitality lodging establishment. The hospitality lodging establishment, which may be referred to as a property P and, as depicted, a hospitality property, may be a furnished multi-family residence, dormitory, lodging establishment, hotel, hospital, or other multi-unit environment. As shown, by way of example and not by way of limitation, the property P is depicted as a hospitality establishment H having various rooms, including rooms R (see FIGS. 2A and 2B), and spaces E (see FIGS. 2A and 2B).

As illustrated, in one embodiment, within the property P, the system 10 includes the thermostat 12, which has a housing 14 having an interface 16 showing an actual temperature 18 and a setpoint temperature 20. The thermostat 12 monitors and controls heating and cooling on the property P, or a portion thereof, to the setpoint temperature 20, which is adjustable, through communication between the thermostat 12 and an HVAC system 22. The thermostat 12 also provides Internet-of-Things (IoT) functionality to communicate with Internet-of-Things (IoT)-enabled devices to monitor and control the behavior of various proximate amenities via an amenity status/control suite 28.

As shown, the amenity status/control suite 28 represents the status and control of various amenities, such as hospitality amenities, associated with an individual I in the property P. The various amenities may include a television 30, lights 32, window shades 34, and security 36, for example. The thermostat 12 also connects a guest with various service options. A service suite 38 represents a set of services associated with a guest staying, for example, in the property P. The various services may include maid service 40, pool reservations, and food delivery service 42, for example.

In one embodiment, the individual I, who may be a guest at the property P, may issue voice commands, such as signal S₁, from a distance to the thermostat 12 in order to control the setpoint temperature 20, for example, or interact with the amenity status/control suite 28 or the service suite 38. The thermostat 12 is also communicatively disposed with a proximate wireless-enabled programmable device 46, which is illustrated as a tablet computer having a touch screen display. Although a tablet computer is depicted, the proximate wireless-enabled programmable device 46 may be a personal computer, laptop, tablet computer, smart phone, smart speaker, smart television, or smart watch, for example. The individual I, is utilizing the proximate wireless-enabled programmable device 46 to issue commands, such as signal S₂, from a distance to the thermostat 12, which communicates with wireless signal S₃, in order to control the setpoint temperature 20 via the thermostat 12, for example, or interact with the amenity status/control suite 28 or the service suite 38, both of which may use wireless communication represented by signal S₄. In one implementation, an application installed from a server enables the thermostat 12 and the proximate wireless-enabled programmable device 46 to be wirelessly paired. In another embodiment, a challenge-response is utilized to wirelessly pair the thermostat 12 and the proximate wireless-enabled programmable device 46. As shown on the programmable device, a menu 48 is presented that further enables the use by the individual I of the amenity status/control suite 28 and the service suite 38.

The thermostat 12 collects various thermostat data including physical data 52, physical quality assurance data 54, program data 56, program quality assurance data 58, interactive data 60, environmental data 62, and IoT/Service data 64. Additionally, the thermostat data 50 includes identification data 66 identifying the thermostat 12 as well as self-diagnostic data 68. In one embodiment, the physical data 52 includes the actual hardware specifications and arrangement of connections at time of installation. The physical quality assurance data 54 may be physical state data relating to a current condition of the hardware and the cable connections. The program data 56 may include information about the system software that engages the thermostats hardware and information about the application software that provides functionality relating to a guest's or hotel's interest, for example. The program quality assurance data 58 may be software state data relating to the current operations of the system software and the application software. In one embodiment, the interactive data 60 includes information about the display-based interactions of a guest with the thermostat. The environmental data 62 includes information about the non-display-based interactions of a guest with the thermostat. The IoT/Service data 64 includes information about a guest's use of the amenity status/control suite 28 and the service suite 38. In one implementation, the identification data 66 may include the location of the thermostat as well as other information derived from the physical data 52 and the program data 56, which identifies the thermostat. The self-diagnostic data 68 relates to an application running automatically at a regular interval or continuously, for example, that detects faults—typically before becoming serious—in the physical data 52, the physical quality assurance data 54, the program data 56, the program quality assurance data 58, the interactive data 60, or the environmental data 62, for example.

By way of example, and not by way of limitation, the physical data 52 may be processor specifications, memory specifications, storage specifications, wireless specifications, firmware versions, connection to display by type, connection to display by model number, network addressing, MAC addresses, or the like. The physical quality assurance data 54 may be online/offline status, power state, display control status, display connection status, HDMI interface status, control interface status, memory usage, unit up-time, hardware installation progress, or the like. The program data 56 may be user interface software version, operating system version, settings version, welcome menu version, and software configuration, or the like. The program quality assurance data 58 may be program guide status, debug console log, software usage, and software installation progress, or the like. The interactive data 60 may be guest configuration data, television channel viewing, guest climate preference including setpoint temperature as adjusted, program viewing, Internet history, program guide interaction, or the like. The environmental data 62 may be amenity interaction, lighting status, thermostat status, window shades status, door status, or the like. The environmental data 62 may include information about cooling cycles, heating cycles, and setpoint temperature data, for example. The IoT/Service data 64 may also include various data about amenity and service interactions and, in one embodiment, the IoT/Service data may compliment the environmental data 62. The identification data 66 may be the serial number and addressing information gathered from the physical data, software identification information gathered from the program data, room number assigned to the thermostat, or the like. The self-diagnostic data 68 may be percent online, display output errors, self-test results, thermostat health reports, or the like.

As will be discussed in further detail hereinbelow, a map view 70 of the hospitality establishment H, including the property P, may be rendered by the system 10 as part of and following the collection of the thermostat data 50. More particularly, in one operational embodiment of the system, as discussed, the thermostat stores various types of thermostat data 50 and transmits the thermostat data 50. The system 10 receives and stores the thermostat data 50. The system 10 may render the map view 70 of the hospitality establishment based on obtained map data, as will be discussed in more detail hereinbelow. The map view may include a graphical representation of the property P, including one or more rooms at the hospitality establishment. The system 10 may annotate the graphical representation of the room with at least a portion of the thermostat data 50.

The thermostat data 50 has uses other than the rendering of the map view 70. By way of example, collection of the thermostat data 50 permits hotel guests to tailor their specific ambient environmental conditions, like temperature, shades, lighting, and program guide, and to store those preferences for future hotel stays by providing a means to learn a guest's preferences in a central database then store those preferences for future stays thus allowing the guest to reuse the preferences in future stays regardless of the make and model of the various amenities in the hotel room. Stored television and heating and cooling and lighting preferences by way of example, may be stored and retrieved using two methods. First, in a hotel brand database and installed in a specific guest room based on loyalty program membership identifier. These preferences would be automatically provided to the thermostat 12 as the guest checks into the hotel or self-applied by the guest through registration in an internet-based system accessible to guests during their hotel stay at any property so equipped.

Thermostat data 50 may be collected for an application such as an adaption program guide that allows guests to customize the interactive program guide at his or her thermostat 12. By way of example, and not by way of limitation, the adaption program guide may include the following:
Presentation of a sub-set of the items available in the interactive program guide such as only sports channels, a specific list of channels of interest to the specific guest, only over-the-top programming, or any combination of these items. Items for display on a television or smart device may be selectable either as discrete items available for yes/no election by the guest or through groups of like items or services that may be selected as a group for inclusion or elimination from the interactive program guide.
Presentation of the items in the interactive program guide on a television or smart device in a specific order such as sports channels first, followed by over-the-top applications, or any combination of items and services available in the system. Changes in font size, background color, or other graphical features as necessary to improve the system usability for individuals with accessibility challenges may also be included.
Individual guest settings are stored in a database of guest settings indexed by a master index record that could be either the guest's loyalty program membership identifier or a separate identifier, such as the guest's e-mail address. In some situations, a hotelier may choose to use their own system to maintain these records while other hoteliers may choose to use a database system provided by an external service.

Guest specific adaptations to the specific room's interactive program guide can be applied through automated features utilizing the hotel's property management system and its ability to store hotel loyalty membership information for a specific guest. The teachings herein provide a feature to retrieve a guest's interactive program guide adaptations they created at a previous hotel stay and automatically apply those settings to a current hotel stay by retrieving the guest's hotel loyalty membership number from the hotel property management system. Once the loyalty number is retrieved, the invention would use that number to look up, retrieve, and then apply the guest's interactive program guide adaptations stored in the system from a previous stay.

Alternatively, some hoteliers may choose to use a completely separate and non-hotel brand specific database to manage guest specific adaptations to the interactive program guide. In this implementation, guests would log into the system in their room using a smart device, for example, such as the proximate wireless-enabled programmable device 46, in any equipped hotel, whereupon the system would download their specific customizations, which would immediately take effect in the rooms. Any customizations made while the guest was logged into the system may then be recorded in the system database and available for future guest stays at any equipped hotel.

Guests personal adaptations may be recorded by either of two methods. These methods can be used independently or together to create and store a guest's personal adaptations. Using the first method, guests may select from an on-screen presentation on the guest's television in the room enabled by the thermostat 12, the channels and services they want to include in their customized interactive program guide. This presentation is constructed using a variety of graphical presentations that could include checkboxes, radio buttons, and checklists or other presentations. Guests may then accept the selected items for display on their television or smart device as enabled by the thermostat. If the guest was a hotel loyalty program member and the hotel has elected to use this feature, the guest's settings may be saved in a database associated with the guest's loyalty membership number. This is in addition to preserving the newly customized settings for the duration of the guest's current stay. If the hotel brand elects to use a brand independent database, the guest's customizations would then be stored in that database using the guest's login information as the record key.

Using the second method, the system may automatically prioritize channels and services based on guest channel usage. Prioritization may be based on multiple factors such as but not limited to:
Channels or services elected for viewing by the guest.
Duration of viewing by the guest of particular channels or services.
Associated channels and services similar to channels or services viewed by the guest based on selection or duration by the guest.

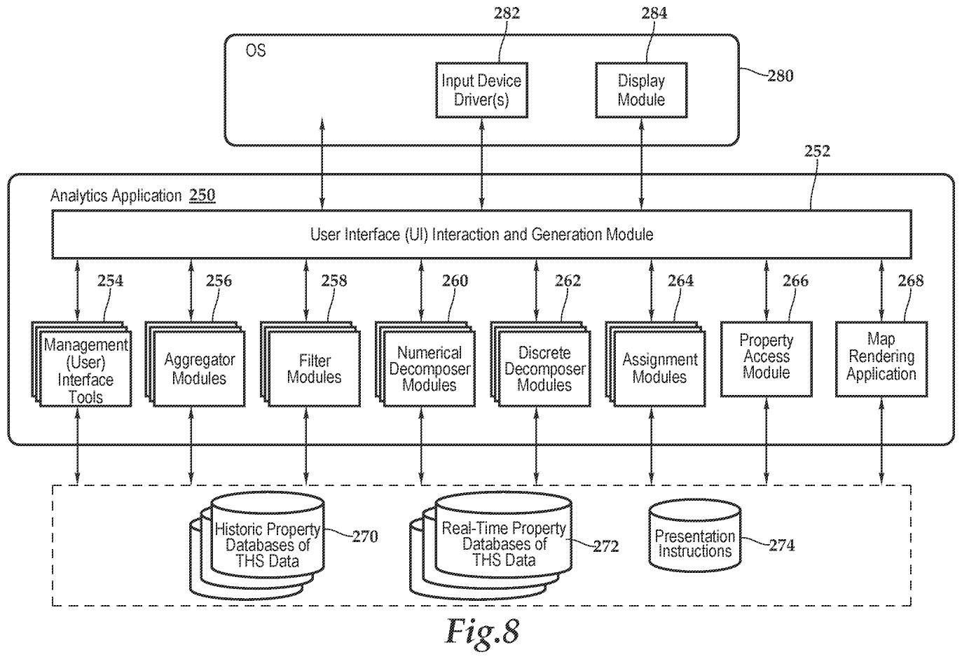

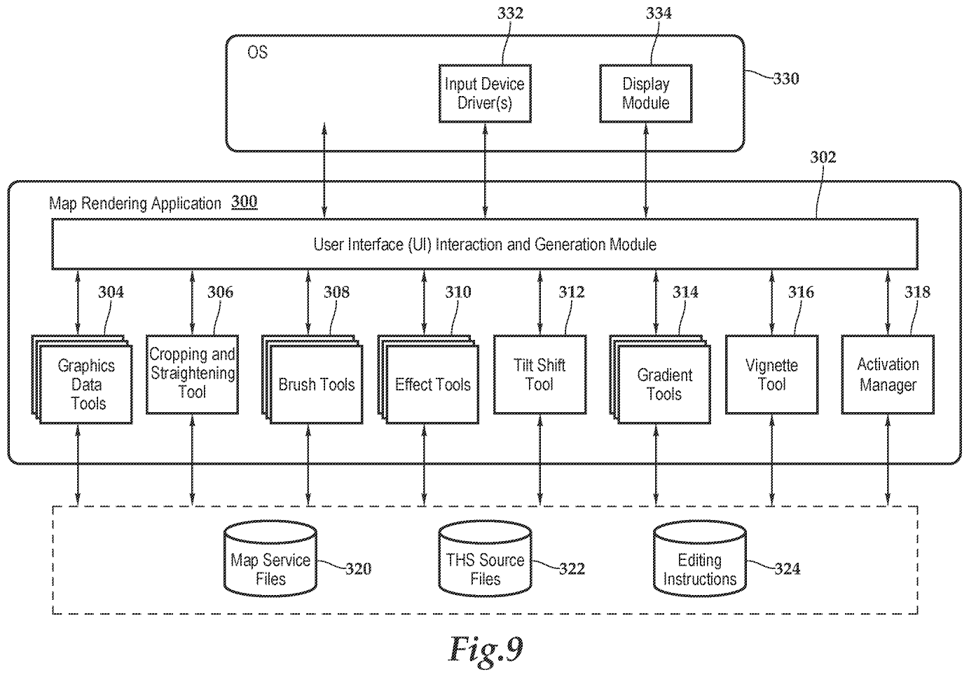

Referring now to FIG. 2A, the system 10 may be deployed such that a server 90 is co-located on the property P-1 having room(s) R and space(s) E with the thermostats 12-1 . . . 12-n. As shown, the server 90 includes a housing 92 having various components and software therein as will be discussed in FIG. 7, FIG. 8, and FIG. 9. In one embodiment, the thermostats 12-1 . . . 12-n send the thermostat data periodically as part of regular broadcasts or in response to an inquiry made from the server 90. The server 90 receives the thermostat data 50 from the thermostats 12-1 . . . 12-m.

The server 90 may render a map view 70 of the hospitality establishment H based on obtained map data. Additionally, the server 90 may render the map view 70 of the hospitality establishment with annotations based on the thermostat data as discussed herein. In some embodiments, the map view 70 may include a graphical representation of one or more rooms R of the hospitality establishment H that are annotated with the thermostat data 50 relative to the physical data 52, the physical quality assurance data 54, the program data 56, the program quality assurance data 58, the interactive data 60, the environmental data 62, the IoT/Service data 64, the identification data, and/or the self-diagnostic data 68. It should be appreciated that the server 90 may be located on a single property to serve one or more thermostats thereon. Further, as shown in FIG. 2B, it should be appreciated that the server 90 may be remotely located to serve multiple properties having multiple thermostats.

Referring to FIG. 2B, the system 10 may be deployed such that the server 90, having the housing 92, is located remotely within cloud C relative to the thermostats 12-1 . . . 12-n, which are located at properties P-1 through P-n. In particular, the server 90 may be located remotely relative to the thermostats 12-1 . . . 12-n such that property headends 94-1 . . . 94-n is interposed between the server 90 and the thermostats 12-1 . . . 12-n. As shown, in this implementation, the property headends 94-1 . . . 94-n are co-located with the thermostats 12-1 . . . 12-n at a respective property, P-1 through P-n. The server 90 may render the map view 70 of the hospitality establishment that may be annotated with the thermostat data 50 as discussed herein.

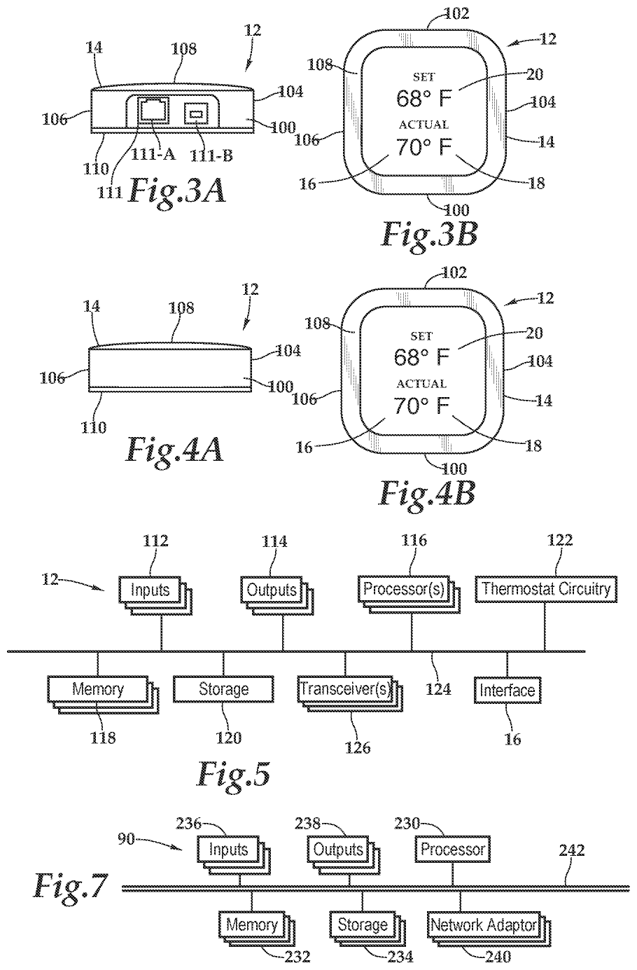

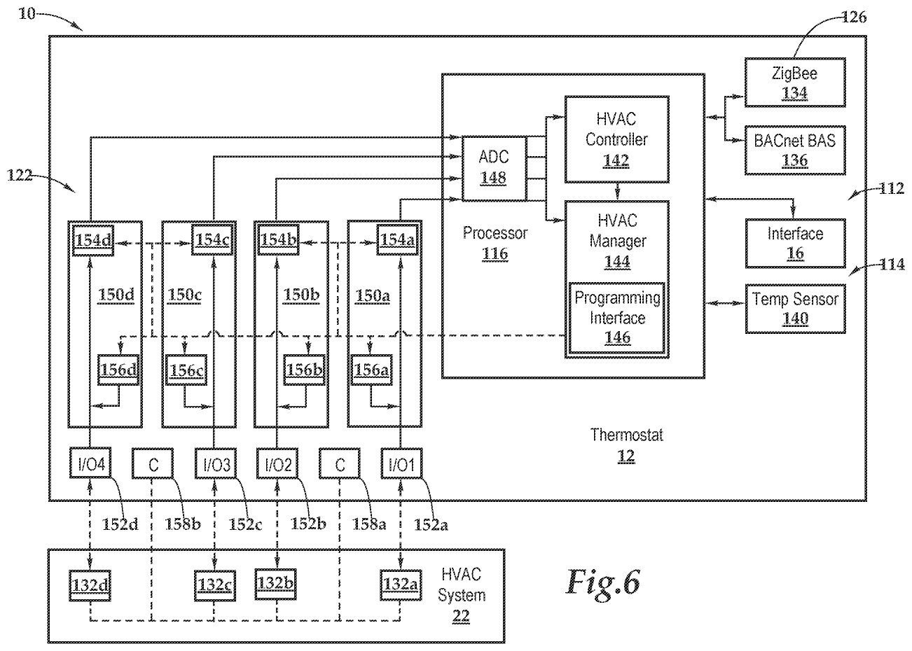

Referring to FIG. 3A and FIG. 3B, the thermostat 12 may be a wall-mounted unit that is an information appliance device that generally contains convenience and data functionality in addition to monitoring and controlling heating and cooling in the room R or other environment to the setpoint temperature 20. The thermostat 12 includes the housing 14 having a front wall 100, a rear wall 102, a side wall 104, a side wall 106, a top wall 108, and a bottom base 110. It should be appreciated that front wall, rear wall, and side wall are relative terms used for descriptive purposes and the orientation and the nomenclature of the walls may vary depending on application. The front wall 100 includes various ports 111, including ports 111-A, 111-B, that provide interfaces for the exchange of information between components, including inputs 112 (please see FIG. 6) and outputs 114 (please see FIG. 6). In one implementation, as illustrated, the port 111-A is an RJ45 port and the port 111-B is a USB2 port. It should be appreciated that the configuration of ports may vary with the thermostat depending on application and context. As previously discussed, the thermostat 12 monitors and controls heating and cooling in the space E or the room R to a setpoint temperature as shown by the interface 16, which may be a display, providing a user interface, that provides the temperature data 18, such as the setpoint temperature [shown as 68° F. (20° C.)] and the actual temperature [shown as 70° F. (21° C)]. By way of further example, referring to FIG. 4A and FIG. 4B, the thermostat 12 may have no additional ports.

Referring now to FIG. 5, within the housing 14, the interface 16, the inputs 112, the outputs 114, a processor or processors 116, memory 118, storage 120, and thermostat circuitry 122 are interconnected by a bus architecture 124 within a mounting architecture. The processor 116 may process instructions for execution within a computing device, including instructions stored in the memory 118 or in the storage 120. The memory 118 stores information within the computing device. In one implementation, the memory 118 is a volatile memory unit or units. In another implementation, the memory 118 is a non-volatile memory unit or units. The storage 120 provides capacity that is capable of providing mass storage for the thermostat 12 and store, for example, the thermostat data 50. The various inputs 112 and outputs 114 provide connections to and from the computing device, wherein the inputs 112 are the signals or data received by the thermostat 12, and the outputs 114 are the signals or data sent from the thermostat 12.

A transceiver or transceivers 126 is associated with the thermostat 12 and communicatively disposed with the bus architecture 124. As shown the transceiver 126 may be internal, external, or a combination thereof to the housing. Further, the transceiver 126 may be a transmitter/receiver, receiver, or an antenna for example. Communication between various amenities in the hotel room and the thermostat 12 may be enabled by a variety of wireless methodologies employed by the transceiver 126, including 802.11, 3G, 4G, Edge, WiFi, ZigBee, near field communications (NFC), Bluetooth low energy, and Bluetooth, for example. Also, infrared (IR) may be utilized. As previously discussed, the transceiver 126 is configured to be joined in network communication with an environmental amenity or amenities that are co-located within the room of the respective thermostat 12. It should be appreciated however, that communication between various amenities in the room and the thermostat 12 may be enabled as well by a variety of wired technologies, such as, for example, the wired technologies presented in FIG. 3A and FIG. 3B

The memory 118 and storage 120 are accessible to the processor 116 and include processor-executable instructions that, when executed, cause the processor 116 to execute a series of operations. The processor-executable instructions cause the processor to analyze the thermostat data 50 for defaults and store resultant self-diagnostic data. The processor-executable instructions also cause the processor to store the thermostat data 50. The processor-executable instructions may also cause the processor to send the thermostat data 50, or a portion thereof, and to send the self-diagnostic data either separately or with and as part of the thermostat data. The thermostat data 50 may be sent periodically or continuously or in response to a request from the server 90, for example.

FIG. 6 depicts another operational embodiment of a portion of the thermostat 12 shown in FIG. 5. In this operational embodiment, the thermostat 12 is located in communication with the HVAC system 22, which may be servicing the space E and/or the hotel H, for example. The HVAC system 22 includes terminal connections 132a, 132b, 132c, and 132d providing an interface to various components of the HVAC system 22, including cooling, heating, humidity, and electronic air cleaning, for example. The terminal connections 132a, 132b, 132c, 132d are provided by way of nonlimiting example and it should be appreciated that the number and configuration of terminal connections may vary depending on the HVAC system 22 and application.

As shown, the thermostat circuitry 122 is interposed between the processor 116 and the HVAC system 22. The transceiver 126 communicates with the processor 116 and the transceiver 126 is depicted as a ZigBee antenna 134 in this embodiment. The inputs 112 and the outputs 114 to the thermostat 12 include a wired input/output device 136, the interface 16 for a user, and a temperature sensor 140.

In the illustrated embodiment, the processor 116 includes an HVAC controller 142, an HVAC manager 144 having a programming interface 146, and an analog-to-digital (ADC) converter 148. The thermostat circuitry 122 includes interface circuits 150a, 150b, 150c, 150d coupled to terminal interfaces 152a, 152b, 152c, 152d. Each of the interface circuits 150a, 150b, 150c, 150d have an amplification circuit 154a, 154b, 154c, 154d and an input/output circuit 156a, 156b, 156c, 156d.

The processor 116 may execute machine-readable instructions stored in memory on behalf of the thermostat 12. By way of example, the processor 116 may include a microprocessor having one or more cores, microcontroller, application-specific integrated circuit (ASIC), digital signal processor, digital logic devices configured to execute as a state machine, analog circuits configured to execute as a state machine, or a combination of the above, for example. The processor 116 stores instructions that may include at least one of HVAC controller logic embodied in the HVAC controller 142 and configurable input and output manager logic embodied in the HVAC manager 144. In one embodiment, the HVAC manager 144 may include the programming interface 146, which is configured to communicate with the thermostat 12 and provide process-executable instructions thereto by way of non-transitory memory accessible to the processor 116.

The HVAC controller 142 is configured to receive and store user selectable configuration parameters for configuring, via the HVAC manager 144, the terminal connections 132a, 132b, 132c, 132d of the HVAC system 22 as part of the monitoring and controlling of heating and cooling in a room or other environment to a setpoint temperature. The HVAC controller 142 communicates the various configuration parameters and the setpoint temperature to the HVAC manager 144, which may also receive configuration parameters from the programming interface 146.

In the illustrated embodiment, the HVAC manager 144 generates and outputs a group of configuration control signals for each of the input/output circuits 156a, 156b, 156c, 156d and each associated amplification circuit 154a, 154b, 154c, 154d of the interface circuits 150a, 150b, 150c, 150d based on the parameters to communicate with the HVAC system 22. Once the terminal interfaces 152a, 152b, 152c, 152d have been configured for a respective input or output interface signal type by the interface circuits 150a, 150b, 150c, 150d, the amplification circuits 154a, 154b, 154c, 154d may employ one or more of the configuration control signals to scale and normalize the feedback signals from the respective terminal interfaces 152a, 152b, 152c, 152d to the interface circuits 150a, 150b, 150c, 150d, which, in turn, drive signals to the ADC 148, which, as mentioned, forms a portion of the processor 116. The ADC 148 converts the feedback signal to a multi-bit digital signal that be provided to or stored in memory associated with the processor 116 for access by both the HVAC controller 142 and the HVAC manager 144 for further processing. As shown in the implementation presented in FIG. 6, the thermostat 12 may also include one or more common, neutral return or earth ground terminals 158a and 158b for connecting to a respective common, neutral return or earth ground connection of the HVAC system 22, for example.

As mentioned hereinabove, in one implementation, the thermostat 12 includes the transceiver 126, shown as the ZigBee antenna 134. The thermostat 12 may also include the wired input/output device 136 that may employ a standard network communication protocol, such as BACnet™ or other network protocol, for enabling signal communication to and from the thermostat 12. The thermostat 12 may further include the interface 16 coupled to the processor 116 via a standard bus or other bi-directional parallel or serial communication protocol connection. The interface 16 may be a standard touch screen or combination of a keyboard and display, or other input/output device. When executing instructions provided by a user or programming software or firmware contained in a setup or configuration application, for example, the processor 116 may generate and display a screen via the interface 16 that includes a user selectable settings input to enable a user, whether a guest, a resident, a technician, or a thermostat installer, to identify system parameters to the processor 116 pertaining to the HVAC system 22. The temperature sensor 140 provides input regarding the temperature at or near the thermostat 12 within the space E, for example. It should be appreciated that although a particular thermostat architecture is presented in FIG. 6, other architectures are withing the teachings presented herein.

Referring now to FIG. 7, one embodiment of the server 90 as a computing device includes a processor 230, memory 232, storage 234, inputs 236, outputs 238, and a network adaptor 240 interconnected with various buses 242 in a common or distributed, for example, mounting architecture. In other implementations, in the computing device, multiple processors and/or multiple buses may be used, as appropriate, along with multiple memories and types of memory. Further still, in other implementations, multiple computing devices may be provided and operations distributed therebetween. The processor 230 may process instructions for execution within the server 90, including instructions stored in the memory 232 or in storage 234. The memory 232 stores information within the computing device. In one implementation, the memory 232 is a volatile memory unit or units. In another implementation, the memory 232 is a non-volatile memory unit or units. Storage 234 includes capacity that is capable of providing mass storage for the server 90. Various inputs 236 and outputs 238 provide connections to and from the server 90, wherein the inputs 236 are the signals or data received by the server 90, and the outputs 238 are the signals or data sent from the server 90. The network adaptor 240 couples the server 90 to a network such that the server 80 may be part of a network of computers, a local area network (LAN), a wide area network (WAN), an intranet, a network of networks, or the Internet, for example.

The memory 232 and storage 234 are accessible to the processor 230 and include processor-executable instructions that, when executed, cause the processor 230 to execute a series of operations. In one embodiment, the processor-executable instructions cause the processor to receive the thermostat data from the thermostat as well as receive the self-diagnostic data from the thermostat. The processor-executable instructions may then cause the processor to store the thermostat data from the thermostat in a database, which may be associated with the storage. The self-diagnostic data from the thermostat may also be caused to be stored in the database. The processor-executable instructions then cause the processor to render a map view of the hospitality establishment based on obtained map data. As previously discussed, the map view may include a graphical representation of the room and a plurality of other rooms at the hospitality establishment. The processor-executable instructions may then access the database and annotate the graphical representation of the room with at least a portion of the thermostat data.

In some embodiments, the processor-executable instructions cause the processor to render a map view of the hospitality establishment based on obtained map data and the map view may include a graphical representation of the room and other rooms at the hospitality establishment. The processor-executable instructions, when executed, may cause the processor to render a 3-D perspective view of the hospitality establishment, a multi-floor view of the hospitality establishment, a 2-D top plan view of at least a portion the hospitality establishment, or a map view of a floor of the hospitality establishment, for example. The map view may be a virtual model of at least a portion of the physical body of the hospitality establishment, including a virtual model of the physical body of the hospitality establishment.

In some embodiments, the processor-executable instructions cause the processor to at least partially integrate or at least partially combine multiple portions of the thermostat data into the graphical representation of the room. The processor-executable instructions may also include instructions that cause the processor to implement a map application configured to provide a user interface and obtain instructions from a user on the desired map view and annotations.

FIG. 8 conceptually illustrates the software architecture of an analytics application 250 of some embodiments that may render the map view 70 of the hospitality establishment H. In some embodiments, the analytics application 250 is a stand-alone application or is integrated into another application, while in other embodiments the application might be implemented within an operating system 280. Furthermore, in some embodiments, the analytics application 250 is provided as part of a server-based solution or a cloud-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The analytics application 250 includes a user interface (UI) interaction and generation module 252, management (user) interface tools 254, aggregator modules 256, filter modules 258, numerical decomposer modules 260, discrete decomposer modules 262, assignment modules 264, property access module 266, and a map rendering application 268. The analytics application 250 has access to historic property databases of thermostat data 270, real-time property databases of thermostat data 272, and presentation instructions 274, which presents instructions from the operation of the analytics operation 250. In some embodiments, storages 270, 272, and 274 are all stored in one physical storage. In other embodiments, the storages 270, 272, 274 are in separate physical storages, or one of the storages is in one physical storage while the other is in a different physical storage.

The UI interaction and generation module 252 generates a user interface that allows the end user to specify parameters that may be utilized to generate an annotated map view of the hospitality establishment, which may include elements of a heat map. Prior to the generation of an annotated map view of the hospitality establishment, the aggregator modules 256 may be executed to obtain instances of thermostat data. In other instances, the thermostat data is continually provided to the analytics application 250 such that the aggregator modules 256 do not have to obtain instances of thermostat data proactively. The thermostat data may also be filtered by the filter modules 258. The aggregator modules 256 and the filter modules 258 cooperate, in combination, to gather the desired thermostat data.

At this time, the parameters have been established for the annotated map view of the hospitality establishment by default or by an end user utilizing the management (user) interface tools 254. The numerical decomposer modules 260 may be executed to numerically decompose instances or summaries of thermostat data gathered by the aggregator modules 256 and the filter modules 258 by applying the selected performance characteristic or selected performance characteristics to the instances of the thermostat data. The discrete decomposer modules 262 may be executed to containerize the decomposed thermostat data. In this manner, multiple containers may be defined that each have a range of values. The assignment modules 264 may be executed to assign a pre-map annotation element to each of the multiple containers. The property access module 266 may be executed to obtain data from the historic property databases of thermostat data 270 or the real-time property databases of thermostat data 272. The map rendering application 268 may be executed to call a map rendering application 300 of FIG. 9, for example.

In the illustrated embodiment, FIG. 8 includes the operating system 280 that also includes input device driver(s) 282 and a display module 284. In some embodiments, as illustrated, the input device drivers 282 and display module 284 are part of the operating system 280 even when the analytics application 250 is an application separate from the operating system 280. The input device drivers 282 may include drivers for translating signals from a keyboard, mouse, touchpad, tablet, touch screen, gyroscope or accelerometer, for example. A user interacts with one or more of these input devices, which send signals to their corresponding device driver. The device driver then translates the signals into user input data that is provided to the UI interaction and generation module 252.

FIG. 9 conceptually illustrates the software architecture of the map rendering application 300 of some embodiments that may render the map view 70 of the hospitality establishment H. In some embodiments, the map rendering application 300 is a stand-alone application or is integrated into another application, while in other embodiments the application might be implemented within an operating system. Furthermore, in some embodiments, the map rendering application 300 is provided as part of a server-based solution or a cloud-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The map rendering application 300 includes a UI interaction and generation module 302, graphics data tools 304, a cropping and straightening tool 306, brush tools 308, effect tools 310, a tilt shift tool 312, gradient tools 314, a vignette tool 316, and an activation manager 318. The image editing application has access to map service files 320, thermostat source files 322, and editing instructions 324. In some embodiments, the map service files may be vector graphics data files with texture identifiers or two or three dimensional map image files specified in one or more map tiles that may be raster-based map tiles, for example. The map service files 320 create a virtual model of the physical body of the hospitality establishment H based on definitions derived from any GIS resources, such as a geodatabase, address location, map document, geoprocess model, or any two- or three-dimensional CAD-based drawings and plans.

The thermostat source files 322 store operational instructions for processing thermostat data. The editing instructions 324 store the image editing operations that the map rendering application 300 performs as a set of instructions. The map rendering application 300 uses these set of instructions to generate new images based on the original data stored in the source files. In some embodiments, the map image files and/or media content data are stored as .mov, .avi, .jpg, .png, .gif, pdf, .mp3, .bmp, .wav, .txt, .tiff, etc. files in the map service files 320 and thermostat source files 322. In some embodiments, storages 320, 322, and 324 are all stored in one physical storage. In other embodiments, the storages 320, 322, 324 are in separate physical storages, or one of the storages is in one physical storage while the other is in a different physical storage.

In the illustrated embodiment, FIG. 9 also includes an operating system 330 that includes input device driver(s) 332 and a display module 334. In some embodiments, as illustrated, the device drivers 332 and display module 334 are part of the operating system 330 even when the image editing application is an application separate from the operating system. The input device drivers 332 may include drivers for translating signals from a keyboard, mouse, touchpad, tablet, touch screen, gyroscope, accelerometer, etc. A user interacts with one or more of these input devices, which send signals to their corresponding device driver. The device driver then translates the signals into user input data that is provided to the UI interaction and generation module 302.

The present application describes a graphical user interface that provides users with numerous ways to perform different sets of operations and functionalities. By either executing a pre-determined series of editing instructions on a pre-determined set of media source files or receiving a selection of media processing operations, the present map rendering application 300 provides for a map view of the hospitality establishment with the appropriate annotations of thermostat data.

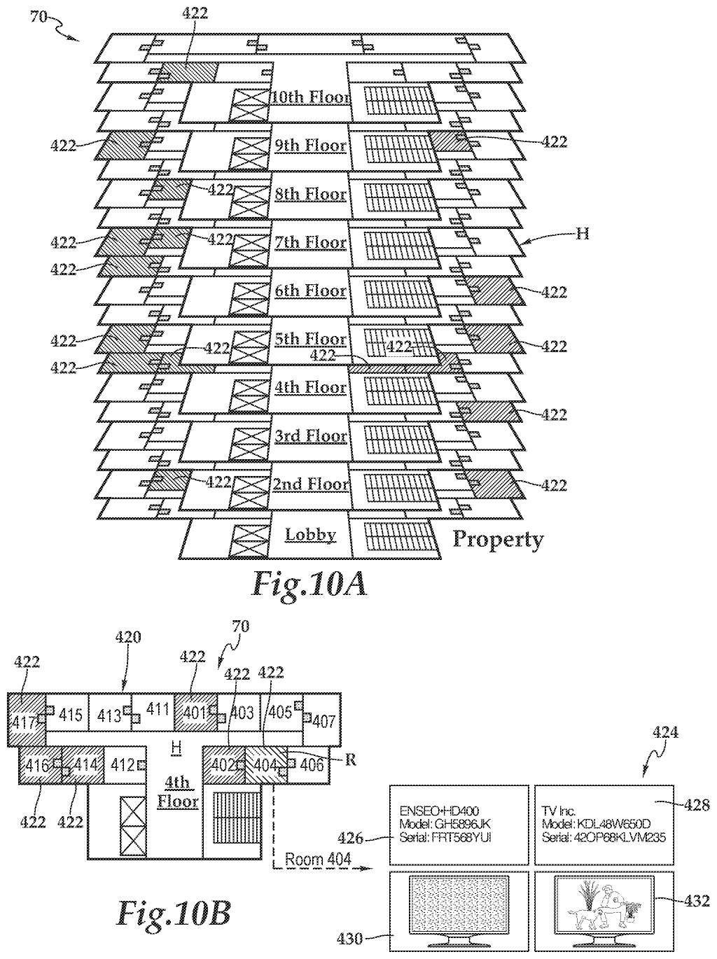

Referring now to FIG. 10A and FIG. 10B, in one implementation, property monitoring and optimization is provided in the form of a database, or as shown, in the map view 70 of the hospitality establishment H including a graphical presentation 420 of a floor of the hospitality establishment H, wherein particular hotel rooms with thermostat data historically and in substantially real time permits a user or manager to select the desired information and make optimal property management decisions. In particular, color-coding and hue assignment adds additional understanding and visibility into housekeeping and maintenance conditions as well as use. By way of example and not by way of limitation, the hospitality establishment is graphical depicted as having a lobby and ten floors, which are lobby, 2^{nd} floor, 3rd floor, etc. For each floor, such as the 4^{th} floor, a floor layout is shown with rooms, such as rooms 401 through 407 and 411 through 417. In FIGS. 10A and 10B, by collecting the substantially real time and historic thermostat data from the field, a map may be shown depicting all rooms with an outstanding data status 422, for example. In particular, room 404 from FIG. 1 is highlighted to inspect the data status 422, which may include the physical data 52, the physical quality assurance data 54, the program data 56, the program quality assurance data 58, the interactive data 60, the environmental data 62, the IoT/Service data 64, the identification data 66, the self-diagnostic data 68, or any subset or combination thereof. With this information and knowledge of the issue, management may appropriately administer the strategy for organizing and coordinating the resources of the property. As mentioned, it should be appreciated that other types of databases and charts may be prepared from the substantially real-time information collected.

As shown, by way of example, the status of Room 404 is being examined as each highlighted room with the outstanding data status 422 is experiencing a problem as indicated by self-diagnostic data 66 received by the server 90. As shown, the graphical representation of Room 404 is annotated with information group 424. For example, information 426 is based on identification data 64 that details the model and serial number of the thermostat associated with the Room 404. Also, included in the annotation is information 428, which is based on the physical data 52 and provides details on the physical connection with the display associated with the thermostat of Room 404. Information 430 shows details on a particular recently viewed channel that is not being received clearly as the self-diagnostic data 66 indicates. Information 432 annotates the map view 70 with the current channel that is being viewed by the guest, based on the interactive data 60. That is, in some embodiments, once the thermostat data 50 is captured, the thermostat data 50 is directly uploaded to the server 90 and a database and then associated with the rooms R shown on the map view 70. Management uses the map view 70 to gather real time information about the status of the rooms and properties and reports on any failures. To view the thermostat data 50 captured from each thermostat in each room, the map view users can select a room from the map and appropriately click or tap on the rooms and then select the thermostat data or other processing operations requested.

The system presented herein provides for the management of hospitality real estate and to the operation, control, and oversight of hospitality properties, such as lodging establishments, motels, or hotels, for example. In one embodiment, a web-hosted, cloud-based property monitoring and troubleshooting tool is furnished that provides a graphical presentation of the hospitality properties with historic and real time room and equipment status. By way of example and not by way of limitation, the user may select to annotate the map view with rooms and equipment online/offline, rooms and equipment percentage online status, groups by percentage, rooms and equipment that are powered off, rooms and equipment TV control status and TV types by model number, rooms and equipment with TV output errors, or rooms and equipment with HDCP errors. Also, possible instructions include to show rooms and equipment by firmware version numbers, show rooms and equipment by UI software version numbers, show rooms and equipment by settings version numbers, show rooms that are tuned to the welcome channel, show rooms that are tuned to a TV channel and group them by channels, show rooms with program guide trouble, show room set top box memory usage, show room self-test results, show rooms with self-test failures, force self-test, view the self-test result, view rooms with failure, force software update, force UI software update, force configuration change, or force power state change. The user may utilize the annotated map view to effect commands to one or more rooms including online/offline, network address, MAC address, hardware configuration and identifiers, software configuration and versions, thermostat connection status, control interface or unit up-time and health reports, cooling cycle data, and heating cycle data, for example. The user may also utilize the system for full access to debug console ports on each thermostat. As mentioned, historic thermostat data may be viewed by property or properties or room or rooms, with user selectable constraints such as data and time. Further, the system may be utilized to monitor the installation process.

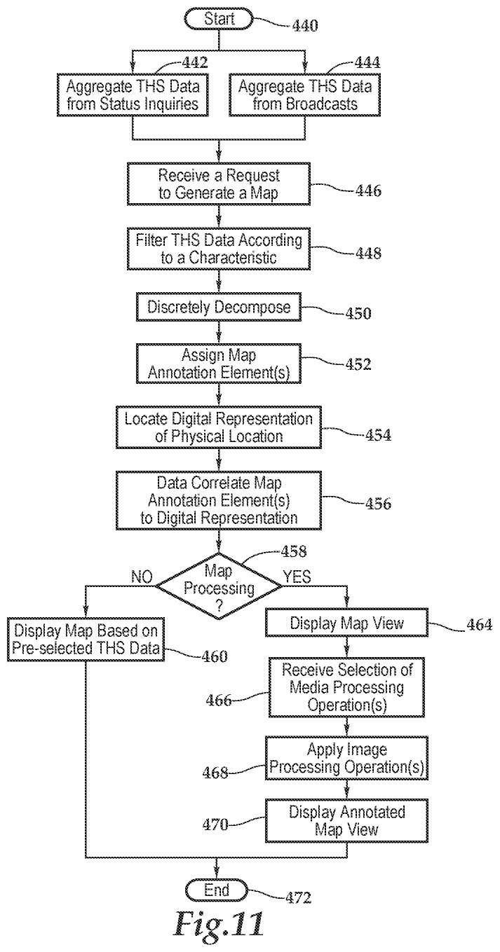

Referring now to FIG. 11, one embodiment of a method for utilizing property management tools for the operation, control, and oversight of hospitality properties, such as lodging establishments, motels, or hotels, for example, is depicted. The methodology starts at block 440 and progresses through block 442 and block 444 where, respectively, thermostat data is aggregated from status inquiries from the server to the thermostats and aggregated from thermostats broadcasting the thermostat data. At block 446, the server receives a request to generate a map view of a particular hospitality property. At block 448, the server filters the aggregated thermostat data according to a characteristic or characteristics. At blocks 450 and 452, the thermostat data is discretely decomposed and assigned annotation elements. At block 454, the digital representation of the physical location, e.g., the hospitality property, is located and at block 456, the data correlation of the map annotation elements to the digital representation occurs.

At decision block 458, if the map processing including any applied annotations are based on a pre-selected or pre-stored or pre-defined criteria, then the methodology advances to block 460 where the appropriate map view is rendered prior to block 472, the methodology ending. On the other hand, at decision block 458, if user input will be sought on the map view and annotations, then the methodology displays the map view at block 464. Then at block 466, the server receives selection of media processing operations from the user and then applies the image processing operations at block 468. The media processing operations may include, for example, selecting the media to be displayed and various luminance, color properties, and such to provide further visibility into the map view. At block 470, the map view with annotations is rendered prior to the methodology ending at the block 472.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for property management, the system comprising:
room data including physical quality assurance data, program quality assurance data, interactive data, and environmental data, the room data being associated with a thermostat in a room at an establishment having a plurality of rooms;
the physical quality assurance data being, relative to the thermostat, physical state data of a current condition of hardware and connections;
the program quality assurance data being, relative to the thermostat, software state data of current operations of system software and application software;
the interactive data being, relative to the thermostat, information about guest-display-based interactions with the thermostat;
the environmental data being, relative to the thermostat, information about guest-non-display-based interactions with the thermostat; and
a server located remote to the room, the server configured to receive the room data.

2. The system as recited in claim 1, wherein the establishment is selected from the group consisting of furnished multi-family residences, dormitories, lodging establishments, hotels, hospitals, and multi-unit environments.

3. The system as recited in claim 1, further comprising:
the server rendering a map view of the establishment based on obtained map data, the map view including a graphical representation of the room and the plurality of rooms at the establishment; and
the server annotating the graphical representation of the room with at least a portion of the room data.

4. The system as recited in claim 3, wherein the server renders a 3-D perspective view of the establishment.

5. The system as recited in claim 3, wherein the server renders a multi-floor view of the establishment.

6. The system as recited in claim 3, wherein the server renders a 2-D top plan view of at least a portion the establishment.

7. The system as recited in claim 3, wherein the server renders the map view of a floor of the establishment.

8. The system as recited in claim 1, wherein the room data further comprises identification data, the identification data including a location of the thermostat.

9. The system as recited in claim 1, wherein the room data further comprises self-diagnostic data, the self-diagnostic data being information relative to faults in the physical quality assurance data, the program quality assurance data, the interactive data, and the environmental data.

10. The system as recited in claim 1, wherein the thermostat further comprises thermostat circuitry.

11. The system as recited in claim 1, wherein the thermostat further comprises thermostat circuitry, the thermostat circuitry monitoring and controlling heating and cooling.

12. The system as recited in claim 1, wherein the physical quality assurance data is selected from the group consisting of online/offline status, power state, display control status, display connection status, HDMI interface status, control interface status, memory usage, unit up-time, and hardware installation progress.

13. The system as recited in claim 1, wherein the program quality assurance data is selected from the group consisting of program guide status, debug console log, software usage, and software installation progress.

14. The system as recited in claim 1, wherein the interactive data is selected from the group consisting of guest configuration data, television channel viewing, program viewing, Internet history, and program guide interaction.

15. The system as recited in claim 1, wherein the environmental data is selected from the group consisting of amenity interaction, lighting status, thermostat status, window shades status, and door status.

16. A system for property management, the system comprising:
room data including physical quality assurance data, program quality assurance data, and interactive data, the room data being associated with a thermostat in a room at an establishment having a plurality of rooms;
the physical quality assurance data being, relative to the thermostat, physical state data of a current condition of hardware and cable connections;
the program quality assurance data being, relative to the thermostat, software state data of current operations of system software and application software;
the interactive data being, relative to the thermostat, information about guest-display-based interactions with the thermostat; and
a server located remote to the room, the server rendering a map view of the establishment based on obtained map data, the map view including a graphical representation of the room and the plurality of rooms at the establishment, and
the server annotating the graphical representation of the room with at least a portion of the room data.

17. The system as recited in claim 16, wherein the thermostat further comprises thermostat circuitry.

18. The system as recited in claim 16, wherein the thermostat further comprises thermostat circuitry, the thermostat circuitry monitoring and controlling heating and cooling.

19. A system for property management, the system comprising:
room data including physical quality assurance data, program quality assurance data, and environmental data, the room data being associated with a thermostat having thermostat circuitry in a room at an establishment having a plurality of rooms;
the physical quality assurance data being, relative to the thermostat, physical state data of a current condition of hardware and cable connections;
the program quality assurance data being, relative to the thermostat, software state data of current operations of system software and application software;
the environmental data being, relative to the thermostat, information about guest-non-display-based interactions with the thermostat; and
a server located remote to the room, the server rendering a map view of the establishment based on obtained map data, the map view including a graphical representation of the room and the plurality of rooms at the establishment, and
the server annotating the graphical representation of the room with at least a portion of the room data.

20. The system as recited in claim 19, wherein the thermostat circuitry monitoring and controlling heating and cooling.
